(19) United States
(12) Patent Application Publication
(10) Pub. No.: US 2009/0125541 A1
(43) Pub. Date: May 14, 2009

(54) OBTAINING AND PROVIDING CONTENT FOR A DICOM TRANSFER CONFIGURATION

(76) Inventor: Franz Amon, Hessdorf (DE)

Correspondence Address: BRINKS HOFER GILSON & LIONE, P.O. BOX 10395, CHICAGO, IL, 60610, US

(21) Appl. No.: 11/937,325

(22) Filed: Nov. 8, 2007

(51) Int. Cl. G06F 17/30; G06F 7/06

(52) U.S. Cl. 707/102; 707/3; 707/E17.005; 707/E17.014

(57) ABSTRACT

A system and method for obtaining and/or providing a DICOM transfer configuration are provided. A database is queried for a first template. The database is configured to store a plurality of templates associated with a respective plurality of nodes. The first template having configuration content of a first node is received as a function of the query. A user interface is populated as a function of the first template. The user interface is used for configuring a DICOM transfer.

### BACKGROUND

The present embodiments relate to data communication. In particular, medical data transfers are configured.

Medical imaging and applications are utilized for research, treatment, and other professional purposes. Sharing of medical data between physicians or entities allows for greater medical care and progress. For example, digital imaging and communications in medicine (“DICOM”) is a standard for storing, printing, and transmitting medical information. DICOM includes a network communications protocol, such as a transmission control protocol (“TCP”) and/or Internet protocol (“IP”). Files can be exchanged between two systems or entities that are capable of receiving image and patient data in DICOM format.

For a DICOM transfer, configuration between devices or systems is performed. For example, when sending data from an origin system to a target or destination system, configuration data, such as a port number and a DICOM service of the destination system, is entered into a transfer application or program. Such configuration data is procured from a customer or vendor.

However, the entering of the configuration data involves manual input for each DICOM transfer. For example, an administrator, technician, or other professional at an origin system types or enters the data into a user interface for transmitting or retrieving data to or from a destination system. Such a process is relatively time consuming as well as prone to errors.

### BRIEF SUMMARY

By way of introduction, the preferred embodiments described below include a database, a user interface, and/or methods of obtaining and/or providing content for a DICOM transfer configuration. A plurality of templates including information for a DICOM transfer configuration are generated and stored in a database. Respective templates are obtained when configuring a DICOM transfer from one node to another node.

According to a first aspect, a method of obtaining content for a digital imaging and communications in medicine (“DICOM”) transfer configuration is provided. A database is queried for a first template. The database is configured to store a plurality of templates associated with a respective plurality of nodes. The first template having configuration content of a first node is received as a function of the query. A user interface is populated as a function of the first template. The user interface is used for configuring a DICOM transfer.

According to a second aspect, a method of providing content for a digital imaging and communications in medicine (“DICOM”) transfer configuration is provided. Data associated with a first node is obtained. The data is used for a DICOM transfer. A first template is generated as a function of the obtained data. The first template is stored in a database. The database is configured to store a plurality of templates associated with a respective plurality of nodes. The database is operable to send the first template to a second node requesting the first template.

According to a third aspect, an apparatus for a digital imaging and communications in medicine (“DICOM”) transfer configuration is provided. A database is operable to communicate with a plurality of nodes. The database is configured to store a plurality of templates. The plurality of templates include configuration content. The database is further operable to send a first template to a first node as a function of a request. The first node is operable to apply the first template for a DICOM transfer.

According to a fourth aspect, a computer-readable medium has stored therein instructions executable by a processor in a system for a digital imaging and communications in medicine (“DICOM”) transfer configuration. The instructions comprise querying a database for a first template corresponding to a first node. The database is configured to store a plurality of templates associated with a respective plurality of nodes. The first template is received based on the query. The first template contains content for a DICOM configuration. A user interface is displayed. The user interface is populated as a function of the content.

The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a general diagram illustrating one embodiment of a data communication system;

FIG. 2 is illustrates one embodiment of a user interface for a DICOM transfer in the system of FIG. 1;

FIG. 3 is a flow chart of one embodiment of a method of providing content for a DICOM transfer configuration; and

FIG. 4 is a flow chart of another embodiment of a method of obtaining content for a DICOM transfer configuration.

### DETAILED DESCRIPTION OF THE DRAWINGS AND PRESENTLY PREFERRED EMBODIMENTS

In one example, for each medical product, a template file is created that contains essential DICOM configuration data. The template files are stored at a central headquarters or a database that can be reached via a remote connection. Using a user interface, the template files can be accessed directly by medical devices at customer sites via the remote connection. Therefore, configuration data is automatically transmitted to a facility or equipment by selecting an applicable product. The template files are generated once and may not need to be generated again at each customer site. By using a template file, substantially less incorrect inputs or errors may occur.

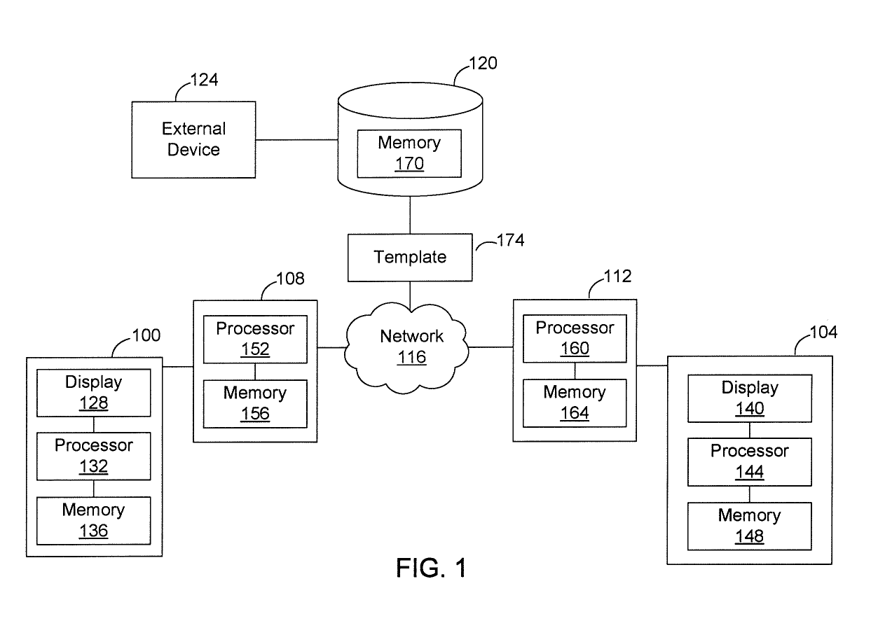

FIG. 1 shows one embodiment of a data communication system. For example, the system is a DICOM system including, but not limited to, a node 100, a node 104, a server 108, a server 112, a network 116, a database 120, and an external device 124. Additional, different, or fewer components may be provided. For example, a proxy server, a billing server, a router, a switch or intelligent switch, a separate computer or workstation, administrative components, such as an administrative workstation, and/or a gateway device may be provided.

The node 100 is a software application and/or hardware implementation of an imaging modality, database or storage file, a workstation, or printer. For example, the node 100 is a magnetic resonance imaging (“MRI”) system or scanner, a computed tomography (“CT”) system or scanner, an X-ray system or scanner, a workstation, a personal computer, or any other known or future imagining modality. The node 100 includes a display 128, a processor 132, and a memory 136. Additional, different, or fewer components may be provided.

The processor 132 is in communication with the display 128 and the memory 136. The processor 132 may be in communication with more or fewer components. The processor 132 is a general processor, application-specific integrated circuit (“ASIC”), digital signal processor, field programmable gate array (“FPGA”), digital circuit, analog circuit, or combinations thereof. The processor 132 is one or more processors operable to control and/or communicate with the various electronics and logic of the node 100. The processor 132 is operable to execute or run DICOM commands and transfer protocols.

The display 128 is any mechanical and/or electronic display positioned for accessible viewing in, on, or in communication with the node 100. For example, the display 128 is a touch screen, liquid crystal display (“LCD”), cathode ray tube (“CRT”) display, or a plasma display. The memory 136 is any known or future storage device. The memory 136 is one or more non-volatile and/or volatile memories, such as a Random Access Memory “RAM” (electronic), a Read-Only Memory “ROM” (electronic), or an Erasable Programmable Read-Only Memory (EPROM or Flash memory). A memory network may be provided.

The node 100 is operable to communicate with the node 104. For example, the node 100 is operable to transfer or retrieve medical data or content to or from the node 104 via the DICOM standard. The nodes 100 and 104 communicate with each other through the servers 108 and 104 as well as the network 116. Alternatively, the nodes 100 and 104 communicate with each other without the servers 108 and 122 and/or with a different network or connection.

The node 104 is a software application and/or hardware implementation of an imaging modality, database or storage file, a workstation, or printer. For example, the node 104 is a magnetic resonance imaging (“MRI”) system or scanner, a computed tomography (“CT”) system or scanner, an X-ray system or scanner, a workstation, a personal computer, or any other known or future imagining modality. The node 104 includes a display 140, a processor 144, and a memory 148. Additional, different, or fewer components may be provided. For example, the node 104 does not include a display and is utilized for storing or printing data or content.

The processor 144 is in communication with the display 140 and the memory 148. The processor 144 may be in communication with more or fewer components. The processor 144 is similar to or different than the processor 132 and is operable to execute or run DICOM commands and transfer protocols. The display 140 and the memory 148 are similar to or different than the display 128 and the memory 136, respectively.

The server 108 and/or 112 is a provider server, application server, communications server, database server, proxy server, file server, web server, client server, peer-to-peer server, and/or any known or future server or combinations thereof. Alternatively, the server 108 and/or 112 is any other device operable to receive or intercept data or data packets over the network 116.

The server 108 and/or 112 is a software and/or hardware implementation. For example, the server 108 and/or 112 is an application program. Alternatively, the server 108 and/or 112 is a server computer or any other hardware that executes and runs server applications. A hardware implementation of the server 108 includes, but is not limited to, a processor 152 and a memory 156, and a hardware implementation of the server 112 includes, but is not limited to, a processor 160 and a memory 164. Additional, different, or fewer components may be provided. The processor 152 is in communication with the memory 156, and the processor 160 is in communication with the memory 164. The processors 152 and 160 may be in communication with more or fewer components.

The processor 152 and/or 160 is a general processor, application-specific integrated circuit (“ASIC”), digital signal processor, field programmable gate array (“FPGA”), digital circuit, analog circuit, or combinations thereof. The processor 152 and/or 160 is one or more processors operable to communicate with electronics of the server 108 and/or 112, respectively, or other components of the system. The memory 156 and/or 164 is any known or future storage device, such as a database or image archival memory. The memory 156 and/or 164 is a non-volatile and/or volatile memory, such as a Random Access Memory “RAM” (electronic), a Read-Only Memory “ROM” (electronic), or an Erasable Programmable Read-Only Memory (EPROM or Flash memory).

The network 116 is any network operable to transfer data or content for a DICOM standard. For example, the network 116 is the Internet, an intranet, a local area network (“LAN”), a wide area network (“WAN”), a virtual private network (“VPN”), and/or any known or future network. Wired and/or wireless connections may be provided. A backbone, network interfaces, network ports, and other network devices may be provided.

The database 120 is operable to communicate with the nodes 100 and 104 via the network 116. The database 120 is operable to communicate with more or less nodes. Alternatively, the database 120 is operable to communicate with the nodes 100 and 104 with a different network or connection. The database 120 is a software file or a hardware implementation. For example, the database is a data server or workstation. Alternatively, the database is an office or headquarters.

The database 120 includes a memory 170. Additional, different, or fewer components may be provided. For example, one or more processors may be provided. The memory 170 is a non-volatile and/or volatile memory, such as a Random Access Memory “RAM” (electronic), a Read-Only Memory “ROM” (electronic), or an Erasable Programmable Read-Only Memory (EPROM or Flash memory). The memory 170 is used as a file storage or look-up-table (“LUT”). For example, a plurality of templates 174 containing DICOM configuration content are stored and/or are operable to be stored in the memory 170. The plurality of templates 174 are associated with a respective plurality of nodes. Each node is a product of a vendor or customer. The database 120 is operable to transmit at least one of the templates 174 to a node, such as the node 100 or 104, based on a query or request.

Each template 174 is a file that includes DICOM configuration content. For example, each template 174 is an extensible markup language (“XML”) file. The DICOM configuration content includes port numbers or identification, application entity titles (“AETs”), DICOM service options, and/or transfer syntax, such as a type of compression, corresponding to a node. For example, the DICOM configuration content is specific to a product, and the database 120 includes at least one template 174 for each product. Therefore, one template 174 corresponds to any number of nodes that are the same product. For example, a vendor may manufacture or sell one thousand units of a product, such as a MRI scanner or other imaging system. All of the thousand units are separate nodes that are of the same product line. Alternatively, each template 174 may be specific to different nodes of the same product line.

An external device 124 is operable to communicate with the database 120. For example, the external device 124 is a remote workstation or node operable to upload new or updated templates to the database 120. The external device 124 is operable to communicate with the database 120 via the network 116 or a different network or connection. Alternatively, the external device is part of the database 120. The external device 124 includes an input device such as, a keyboard, mouse, track-ball, voice recognition circuit, touch screen, or any other input device. Fewer, more, or different components may be provided.

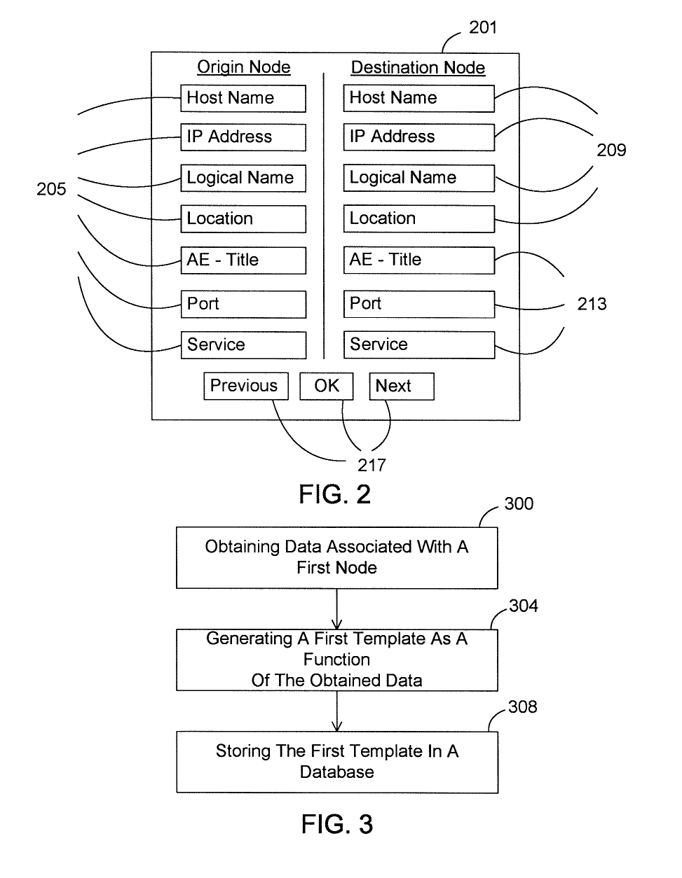

FIG. 2 illustrates one embodiment of a user interface 201 for a DICOM transfer. The user interface 201 is displayed on a display associated with an origin node, such as the display 128, the display 140, the external device 124, or a separate display. The user interface 201 includes data fields 205, data fields 209, data fields 213, and software buttons 217. Fewer, more, or different features may be provided. The data fields are indicators, drop down menus, and/or selection fields relating to at least one origin node and one destination node, respectively.

For example, the data fields 205 relate to an origin node, such as the node 100 or the node 104. The data fields 205 correspond to configuration content such as a host name, an IP address, a logical name, a location, an application entity title, a port, and a DICOM service or function of the origin node. Fewer, more, or different features may be provided. The configuration content is automatically populated or inserted into the respective data fields 205 by the origin node when a DICOM transfer is being configured. The origin node configuration content is stored in the origin node. Alternatively, the origin node configuration content is inserted into the respective data fields 205 by a user or other device. The origin node configuration content may be stored on another device separate from the origin node.

The data fields 209 correspond to a destination node, such as the node 100 or the node 104. For example, the data fields 209 are associated with content that may not be available in one of the templates 174. The data fields 209 correspond to content such as a host name, an IP address, a logical name, and a location of the destination node. Fewer, more, or different features may be provided. The content directed to the data fields 209 is inserted into the respective data fields by a user or other device when setting up a DICOM transfer from the origin node. Alternatively, all or some of the content for the data fields 209 may be available in at least one of the templates 174.

The data fields 213 also correspond to the destination node. For example, the data fields 213 are associated with configuration content that is available in at least one of the templates 174. The data fields 213 correspond to configuration content such as an application entity title, a port, and/or service or function of the destination node. Fewer, more, or different features may be provided. The configuration content directed to the data fields 213 is automatically inserted or populated into the respective data fields via at least one template 174. Alternatively, the configuration content provided by the at least one template 174 is inserted or populated into a next, previous, or different screen shot of the user interface 201.

The software buttons 217 are provided to guide or maneuver a user through a DICOM transfer configuration. For example, a Previous button allows one to retrace or go back to a previous screen shot. An OK button allows one to execute or accept the data selections for the DICOM transfer. A Next button allows one to move forward to further configuration features or options. Fewer, more, or different software buttons may be provided. For example, the OK and the Next function may be provided with one software button.

FIG. 3 is a flow chart of one embodiment of a method of providing content for a DICOM transfer configuration. Fewer, more, or different acts may be provided. The method is implemented by the system of FIG. 1 or a different system.

In act 300, data associated with a first node is obtained. For example, the first node is a destination node, such as the node 100 or the node 104. The data comprises configuration content, such as an application entity title, a port, and/or service or function of the first node. The data is obtained from a DICOM conformance statement that is provided by one or more vendors of a product or products related to the first node. Alternatively, the data is obtained by the first node in which the first node is operable to transmit the data to a database, such as the database 120, or an external device, such as the external device 124.

In act 304, a first template is generated as a function of the obtained data. For example, the first template is one of the plurality of templates 174. The first template is manually generated by inserting the obtained data into a data file, such as an XML file. Alternatively, the first template is automatically generated via a software program. The first template may be generated by or at the external device 124, the database 120, or a different device or system.

In act 308, the first template is stored in a database, such as the database 120. For example, the first template is uploaded to the database via an external device, such as the external device 124. At least one of a plurality of vendors of products may be able to store templates related to their products. The database is configured to store a plurality of templates. Also, the database is operable to send or transmit the first template or any other stored template to a second node requesting the template. For example, the second node is an origin node being used to configure a DICOM transfer. The template may be originally stored or duplicated to other memories, such as any of the nodes, workstations, a cache, or other devices.

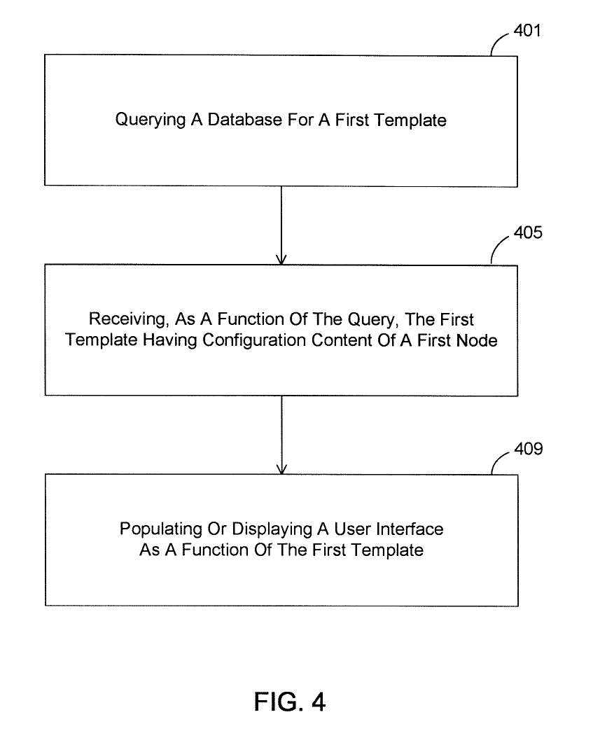

FIG. 4 is a flow chart of one embodiment of a method of obtaining content for a DICOM transfer configuration. Fewer, more, or different acts may be provided. The method is implemented by the system of FIG. 1 or a different system.

In act 401, a database is queried for configuration content, such as data relating to an application entity title, a port, transfer syntax, and/or service or function of a destination node. For example, the configuration content is provided in a first template. The first template is one of the plurality of templates 174. In one embodiment, an origin node, such as the node 100, is being configured to transfer data to the destination node, such as the node 104, via the DICOM standard. The origin node requests a template associated with the destination node from a database, such as the database 120. The request or query is a TCP, IP, or other software or logic command.

The first template may be queried by at least one vendor of a plurality of vendors. For example, different vendors of products may store templates corresponding to their products in the database. Therefore, any one of the vendors may query the database for a template having configuration content of a destination node when setting up a DICOM transfer between nodes. Alternatively, one or more entities, customers, or vendors may have rights over the database and are able to exclude other vendors from using the database or are able to enter into licensing agreements with other vendors regarding the database.

In act 405, the first template is received at the origin node as a function of the query or request. The first template may be received through the same servers, network, or connections used for the request or query. Alternatively, the first template may be received at the origin node via a different connection.

In act 409, a user interface, such as the user interface 201, is populated or displayed as a function of the first template. After receiving the first template, the origin node applies or executes the first template in the user interface. For example, configuration content, such as the configuration content directed to the data fields 213, is automatically included into the user interface on a display of the origin node via the first template. Therefore, a DICOM transfer configuration between nodes may be expedited by using configuration templates.

The logic, software or instructions for implementing the processes, methods and/or techniques discussed above are provided on computer-readable storage media or memories or other tangible media, such as a cache, buffer, RAM, removable media, hard drive, other computer readable storage media, or any other tangible media. The tangible media include various types of volatile and nonvolatile storage media. The functions, acts, or tasks illustrated in the figures or described herein are executed in response to one or more sets of logic or instructions stored in or on computer readable storage media. The functions, acts, or tasks are independent of the particular type of instructions set, storage media, processor, or processing strategy and may be performed by software, hardware, integrated circuits, firmware, micro code, and the like, operating alone or in combination. Likewise, processing strategies may include multiprocessing, multitasking, parallel processing, and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”) or system.

Any of the devices, features, methods, and/or techniques described may be mixed and matched to create different systems and methodologies.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I(We) claim:

1. A method of obtaining content for a digital imaging and communications in medicine (“DICOM”) transfer configuration, the method comprising:
querying a database for a first template, the database configured to store a plurality of templates associated with a respective plurality of nodes;
receiving, as a function of the query, the first template having configuration content of a first node; and
populating a user interface as a function of the first template, the user interface being for configuring a DICOM transfer.

2. The method of claim 1, wherein the first node comprises an imaging modality, a workstation, a storage file, or a printer.

3. The method of claim 1, wherein the plurality of nodes comprises a plurality of products, and wherein each of the plurality of templates corresponds to at least one product of the plurality of products.

4. The method of claim 1, wherein the first template comprises an extensible markup language file.

5. The method of claim 1, wherein the configuration content comprises data indicative of services, port identification, or application entity title of the first node.

6. The method of claim 1, wherein querying the database for the first template comprises querying the database by one vendor of a plurality of vendors.

7. The method of claim 1, wherein the user interface is displayed on a second node, and wherein the DICOM transfer being between the first and second nodes.

8. A method of providing content for a digital imaging and communications in medicine (“DICOM”) transfer configuration, the method comprising:
obtaining data associated with a first node, the data being for a DICOM transfer;
generating a first template as a function of the obtained data;
storing the first template in a database, the database configured to store a plurality of templates associated with a respective plurality of nodes,
wherein the database is operable to send the first template to a second node requesting the first template.

9. The method of claim 8, wherein obtaining the data associated with the first node comprises obtaining the data from a DICOM conformance statement.

10. The method of claim 8, wherein obtaining the data associated with the first node comprises receiving the data from the first node.

11. The method of claim 8, wherein the first template comprises an extensible markup language file.

12. The method of claim 8, wherein the first node is a destination node and the second node is an origin node.

13. The method of claim 8, wherein at least one of the first and second nodes comprises an imaging modality.

14. An apparatus for a digital imaging and communications in medicine (“DICOM”) transfer configuration, the apparatus comprising:
a database operable to communicate with a plurality of nodes,
wherein the database is configured to store a plurality of templates, the plurality of templates having configuration content, and
wherein the database is further operable to send a first template to a first node as a function of a request, the first node operable to apply the first template for a DICOM transfer.

15. The apparatus of claim 14, wherein the database is operable to allow access to multiple vendors.

16. The apparatus of claim 14, wherein each node of the plurality of nodes is associated with a product of a plurality of products, and wherein each of the plurality of templates corresponds to at least one product of the plurality of products.

17. The apparatus of claim 16, wherein the plurality of products comprises products of multiple vendors.

18. The apparatus of claim 14, wherein the first node comprises an imaging modality, a workstation, a storage file, or a printer.

19. In a computer-readable medium having stored therein instructions executable by a processor in a system for a digital imaging and communications in medicine (“DICOM”) transfer configuration, the instructions comprising:
querying a database for a first template corresponding to a first node, the database configured to store a plurality of templates associated with a respective plurality of nodes;
receiving the first template based on the query, the first template containing content for a DICOM configuration; and
displaying a user interface, the user interface being populated as a function of the content.

20. The instructions of claim 19, wherein the content comprises data indicative of services, port identification, or application entity title of the first node.
